(19) United States
(12) Patent Application Publication
(10) Pub. No.: US 2010/0151234 A1
(43) Pub. Date: Jun. 17, 2010

(54) Penetration Resistant Composite and Article Comprising Same

(76) Inventor: Minshon J. Chiou, Chesterfield, VA (US)

Correspondence Address: John E Griffiths;E I Du Pont De Nemours and Company, Legal Patent Records Center, 4417 Lancaster Pike, Wilmington, DE, 19805, US

(21) Appl. No.: 11/990,287

(22) PCT Filed: Aug. 8, 2006
(86) PCT No.: PCT/US06/31146

§ 371 Date: Jul. 2, 2009

Related U.S. Application Data
(60) Provisional application No. 60/707,201, filed on Aug. 10, 2005.

(51) Int. Cl. B32B 5/02; B32B 27/02; B32B 18/00; B32B 15/14; B32B 17/12; B32B 37/00

(52) U.S. Cl. 428/339; 428/500; 428/446; 428/457; 428/426; 156/60

(57) ABSTRACT

Penetration resistant composites and articles that are lightweight and ultraviolet light stable. One penetration resistant composite has a plate and a plurality of fibrous layers disposed adjacent at least one major surface of the plate. At least one of the fibrous layers includes a polymer fiber that is ultraviolet light stable. The composite has an areal density of less than about 25 kilograms per square meter, and is non-penetratable in accordance with standard NIJ-0101.04 level III dated September 2000.

### RELATED APPLICATIONS

This application claims benefit of U.S. Provisional Application No. 60/707,201, filed Aug. 10, 2005, the disclosure of which is incorporated herein by reference in its entirety.

### FIELD OF THE INVENTION

The present invention relates to penetration resistant composites and penetration resistant articles comprising the same. The composites generally include a first layer that may or may not be a rigid plate, and a plurality of fibrous layers disposed adjacent at least one major surface of the first layer.

### BACKGROUND OF THE INVENTION

Personal ballistic body armor, particularly vests, helmets, and other articles, are formed generally of materials which serve to prevent penetration of a bullet or other projectile, and any other object that is forcefully applied to the armor, such as a knife. These articles are primarily used for the armed forces, but also have police and civilian applications. There is a growing demand to improve the wearability and the overall effectiveness of armor systems used by soldiers and police offices in combative environments. Overall thickness and weight of armor systems can effect wearability, but reducing these parameters in currently known systems can compromise the armor's effectiveness against penetration.

One known system that has been used for personal ballistic body armor includes a ceramic plate that is reinforced by one or more fibrous layers. Armor systems employing fibers made from traditional aromatic polymers, such as, for example, polybenzoxazole and poly (p-phenylene terepthalamide), typically require a cover or shield to protect the fibers against ultraviolet (UV) radiation because the radiation decreases the fiber's tensile strength, which in turn decreases the armor's penetration resistance. In some instances, the cover or shield can increase the weight and/or thickness of the armor systems, which cuts directly against the above-noted current demand.

Cunniff, et al., (‘High Performance “M5” Fiber For Ballistics/Structural Composites’-presented at the 23^{rd} Army Science Conference, Dec. 2-5, 2002, Orlando, Fla.) discusses the potential impact of M5 fiber-based armor systems.

Salman, et al., Journal of Lunimescence 2003, 102-103, 261-266, present a study on molecular and supramolecular proton transfer mechanisms of 2-(2′-hydroxyhenyl)-3H-imidazol[4,5-b]pyridine and its derivatives. M5 fiber is based on poly[diimidazo pyridinylene(dihydroxy)phenylene].

U.S. Pat. Nos. 6,408,733 and 6,389,594 concern articles having a ceramic element with an antiballistic material baking.

U.S. Pat. No. 5,635,288 is directed to an antiballistic laminate structure that is supported on a rigid plate. The laminate has a first and second array of unidirectionally-oriented fibers where the second array is cross-piled at an angle with respect to the first array.

U.S. Pat. No. 5,376,426 teaches a penetration resistant composite having a substrate layer with at least two layers affixed to a surface where at least one layer is metal layer and at least one of the layers being a fibrous layer.

Despite the research in this area, there is a need for a lightweight, UV stable composite that is effective against penetration of bullets and other impacting objects.

### SUMMARY OF THE INVENTION

The present invention is directed to lightweight, penetration resistant composite materials with good UV stability. In accordance with one preferred embodiment, there has now been provided a penetration resistant composite, comprising a plate; and a plurality of fibrous layers disposed adjacent at least one major surface of the plate, at least one of the fibrous layers including a polymer fiber having a density of 1.6 grams per cubic centimeter or greater and a tensile strength of at least about 30 grams per denier; wherein the polymer fiber is ultraviolet stable so as to retain at least about 70% of its tensile strength after exposure to a xenon-arc lamp, in accordance with AATCC test method 16-2003, for about 360 hours.

In certain embodiments, the polymer fiber is ultraviolet stable in the absence of additives selected from a group comprising ultraviolet stabilizers and ultraviolet absorbers.

In some embodiments of the invention, the polymer fiber retains at least about 85% of its tensile strength after exposure to a xenon-arc lamp, in accordance with AATCC test method 16-2003, for about 360 hours.

The polymer fiber may include a polyareneazole fiber. One suitable polyareneazole fiber is a poly{2,6-diimidazo[4,5-b:4′,5′-e]pyridinylene-1,4-(2,5-dihydroxy)phenylene} fiber.

In certain embodiments, the polymer fiber has a tensile modulus of greater than about 1,500 grams per denier. In some embodiments, the composite has an areal density of less than about 25 kilograms per square meter.

Some fibrous layers have a total thickness of less than about 7.5 millimeters.

In some embodiments, articles have fibrous layers that are disposed adjacent opposing major surfaces of the plate.

In certain aspects, the invention further comprises a at least one ultraviolet stabilizing agent. Suitable ultraviolet stabilizing agents include benzophenone, benzotriazole, and mixtures thereof.

In some embodiments, the plate comprises ceramic, steel, aluminum, glass, or a polymeric resin.

In accordance with another preferred embodiment of the present invention, there has now been provided a penetration resistant composite, comprising a plate; a plurality of fibrous layers disposed adjacent at least one major surface of the plate, at least one of the fibrous layers including a polymer fiber that is ultraviolet light stable; wherein the composite has an areal density of less than about 25 kilograms per square meter, and is non-penetratable in accordance with standard NIJ-0101.04 level III dated September 2000.

In accordance with yet another preferred embodiment in accordance with the present invention, there has now been provided a penetration resistant composite, comprising a first layer; and a plurality of fibrous layers disposed adjacent at least one major surface of the first layer, wherein the fibrous layers having a total thickness less than about 7.5 millimeters; wherein the composite has an areal density of less than about 25 kilograms per square meter, and is non-penetratable in accordance with standard NIJ-0101.04 level III dated September 2000.

The present invention is also directed to penetration resistant articles that can be worn, carried, or attached to various protective devices, such as, for example, shields and vehicles. Preferred article embodiments include articles employing the above-delineated composites. In some applications, at least a portion of the composite's fibrous layers form an outer surface of the article, that is, the composites are adequately UV stable so that an additional cover or shield are unneeded. It should be noted that alternative composite and article embodiments contemplated by the present invention include a cover or shield, and may further include UV stabilizers and/or UV absorbers.

The invention is also directed to a method of forming a penetration resistant article comprising providing a first layer and disposing a plurality of fiber layers on at least one major surface of the first layer, wherein the polymer fiber is ultraviolet stable so as to retain at least about 70% of its tensile strength after exposure to a xenon-arc lamp, in accordance with AATCC test method 16-2003, for about 360 hours.

These and various other features of novelty, and their respective advantages, are pointed out with particularity in the claims annexed hereto and forming a part hereof. However, for a better understanding of aspects of the invention, reference should be made to the accompanying descriptive matter, in which there is illustrated preferred embodiments.

### DETAILED DESCRIPTION OF ILLUSTRATIVE EMBODIMENTS

The present invention may be understood more readily by reference to the following detailed description of illustrative and preferred embodiments that form a part of this disclosure. It is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The articles of the present invention comprise a first layer, a plate in some embodiments, and a plurality of fibrous layers. In some embodiments, the plate may comprises silicon carbide, silicone nitride, boron carbide, tungsten carbide, or other suitable ceramic materials and hybrids, steel, aluminum, glass, or a polymeric resin. Suitable polymeric resins include polyurethane, polyolefin, phenolic, phenolic polyvinyl butyral rubber blends, polyester, and vinylester resins.

Penetration resistant composites and articles of the present invention preferably include a plurality of fibrous layers that are made from polymer fibers. For purposes herein, the term “fiber” is defined as a relatively flexible, macroscopically homogeneous body having a high ratio of length to width across its cross-sectional area perpendicular to its length. The fiber cross section can be any shape, but is typically round. The fibers can be present in uncoated, or coated, or otherwise pretreated (for example, pre-stretched or heat-treated) form. Herein, the term “filament” is used interchangeably with the term “fiber.”

The fibrous layers can take on numerous configurations, including, but not limited to, knitted or woven fabrics or non-woven structures. By non-woven is meant a network of fibers, including unidirectional (if contained within a matrix resin), felt, and the like. By woven is meant any fabric weave, such as, plain weave, crowfoot weave, basket weave, satin weave, twill weave, and the like. Plain weave is believed to be the most common weave used in the trade.

A representative list of fibers suitable for this invention include polyamide fibers, polyolefin fibers, polybenzoxazole fibers, polybenzothiazole fibers, poly{2,6-diimidazo[4,5-b4′,5′-e]pyridinylene-1,4(2,5-dihydroxy)phenylen} (PIPD) fiber, or mixtures thereof. Preferably, the fibers are made of poly{2,6-diimidazo[4,5-b4′,5′-e]pyridinylene-1,4(2,5-dihydroxy)phenylene} (PIPD) fiber.

When the polymer is polyamide, aramid is preferred. By “aramid” is meant a polyamide wherein at least 85% of the amide (—CO—NH—) linkages are attached directly to two aromatic rings. Suitable aramid fibers are described in Man-Made Fibers—Science and Technology, Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3,354,127; and 3,094,511. Additives can be used with the aramid and it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride or the aramid.

The preferred aramid is a para-aramid and poly(p-phenylene terephthalamide)(PPD-T) is the preferred para-aramid. By PPD-T is meant the homopolymer resulting from approximately mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

When the polymer is polyolefin, polyethylene or polypropylene are preferred. By polyethylene is meant a predominantly linear polyethylene material of preferably more than one million molecular weight that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE). Similarly, polypropylene is a predominantly linear polypropylene material of preferably more than one million molecular weight. High molecular weight linear polyolefin fibers are commercially available. Preparation of polyolefin fibers is discussed in U.S. Pat. No. 4,457,985.

Polyareneazole polymer may be made by reacting a mix of dry ingredients with a polyphosphoric acid (PPA) solution. The dry ingredients may comprise azole-forming monomers and metal powders. Accurately weighed batches of these dry ingredients can be obtained through employment of at least some of the preferred embodiments of the present invention.

Exemplary azole-forming monomers include 2,5-dimercapto-p-phenylene diamine, terephthalic acid, bis-(4-benzoic acid), oxy-bis-(4-benzoic acid), 2,5-dihydroxyterephthalic acid, isophthalic acid, 2,5-pyridodicarboxylic acid, 2,6-napthalenedicarboxylic acid, 2,6-quinolinedicarboxylic acid, 2,6-bis(4-carboxyphenyl)pyridobisimidazole, 2,3,5,6-tetraaminopyridine, 4,6-diaminoresorcinol, 2,5-diaminohydroquinone, 1,4-diamino-2,5-dithiobenzene, or any combination thereof. Preferably, the azole forming monomers include 2,3,5,6-tetraaminopyridine and 2,5-dihydroxyterephthalic acid. In certain embodiments, it is preferred that that the azole-forming monomers are phosphorylated. Preferably, phosphorylated azole-forming monomers are polymerized in the presence of polyphosphoric acid and a metal catalyst.

Metal powders can be employed to help build the molecular weight of the final polymer. The metal powders typically include iron powder, tin powder, vanadium powder, chromium powder, and any combination thereof.

The azole-forming monomers and metal powders are mixed and then the mixture is reacted with polyphosphoric acid to form a polyareneazole polymer solution. Additional polyphosphoric acid can be added to the polymer solution if desired. The polymer solution is typically extruded or spun through a die or spinneret to prepare or spin the filament.

Polybenzoxazole (PBO) and polybenzothiazole (PBZ) two suitable polymers. These polymers are described in PCT Application No. WO 93/20400. Polybenzoxazole and polybenzothiazole are preferably made up of repetitive units of the following structures:

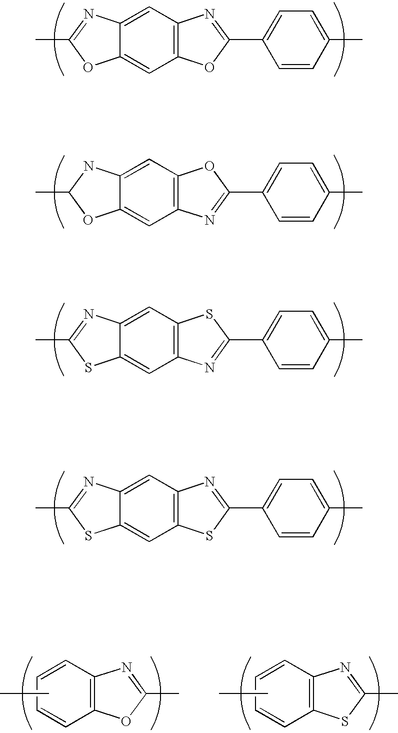

While the aromatic groups shown joined to the nitrogen atoms may be heterocyclic, they are preferably carbocyclic; and while they may be fused or unfused polycyclic systems, they are preferably single six-membered rings. While the group shown in the main chain of the bis-azoles is the preferred para-phenylene group, that group may be replaced by any divalent organic group which doesn't interfere with preparation of the polymer, or no group at all. For example, that group may be aliphatic up to twelve carbon atoms, tolylene, biphenylene, bis-phenylene ether, and the like.

The polybenzoxazole and polybenzothiazole used to make fibers of this invention should have at least 25 and preferably at least 100 repetitive units. Preparation of the polymers and spinning of those polymers is disclosed in the aforementioned PCT application WO 93/20400.

M5 fiber is suitable for use in the instant invention. This fiber is based on poly[diimidazo pyridinylene(dihydroxy)phenylene]. M5 fibers are known to have an average modulus of about 310 GPa and an average tenacities of up to about 5.8 GPa. M5 fibers have been described by Brew, et al., Composites Science and Technology 1999, 59, 1109; Van der Jagt, and Beukers, Polymer 1999, 40, 1035; Sikkema, Polymer 1998, 39, 5981; Klop and Lammers, Polymer, 1998, 39, 5987; Hageman, et al., Polymer 1999, 40, 1313.

A laminated layer is defined as a network of fibers impregnated with a polymeric matrix comprising a thermoset or thermoplastic resin, or mixtures thereof. Each layer adds to the thickness and weight of the composite structure, thereby reducing its flexibility, wearability and comfort. Therefore, the numbers of layers have been selected such that the total composite structure is designed and used to protect against a specific threat.

The layers can be held together or joined in any manner, such as, by being sewn together or they can be stacked together and held, for example, in a fabric envelope or carrier. The layers which form the sections can be separately stacked and joined, or all of the plurality of layers can be stacked and joined as a single unit.

The layers can also be held together by the polymeric matrix comprising a thermoset or thermoplastic resin, or mixtures thereof. A wide variety of suitable thermoset and thermoplastic resins and mixtures thereof are well known in the prior art and can be used as the matrix material. For example, thermoplastic resins can comprise one or more polyurethane, polyimide, polyethylene, polyester, polyether etherketone, polyamide, polycarbonate, and the like. Thermoset resins can be one or more epoxy-based resin, polyester-based resin, phenolic-based resin, and the like, preferably a polyvinlybutyral phenolic resin. Mixtures can be any combination of the thermoplastic resins and the thermoset resins. The proportion of the matrix material in each layer is from about 10% to about 80% by weight of the layer preferably 20% to 60% by weight of the layer.

Various amounts of ultraviolet absorbers or sabilizers can be added to the fiber or laminated layers to absorb harmful ultraviolet radiation and dissipate it as thermal energy. UV absorbers act by shielding the fiber or laminated layers from the UV light, while the UV stabilizers act by scavenging the radical intermediates formed in the photo-oxidation process to enhance the service life of fiber or laminated layers when exposed to UV light. Examples of UV absorbers include benzophenone or the benzotriazole of Ciba Specialty Chemicals.

The linear density of a filament or fiber is determined by weighing a known length of the filament or fiber based on the procedures described in ASTM D1907-97 and D885-98. Fiber “denier” is defined as the weight, in grams, of 9,000 meter of the fiber or filament. And decitex or “dtex” is defined as the weight, in grams, of 10,000 meters of the filament or fiber.

Tensile Properties. The fibers to be tested are conditioned and then tensile tested based on the procedures described in ASTM D885-98. Tenacity (breaking tenacity), elongation to break, and modulus of elasticity are determined by breaking test fibers on an Instron tester.

Ballistic Performance. Ballistic tests of the multi-layer panels are conducted in accordance with NIJ Standard-0101.04 “Ballistic Resistance of Personal Body Armor”, issued in September 2000.

UV stability UV stability of the fiber to be tested are based on AATCC Test Method 16-1998, option E with Xenon light source, “Colorfastness to Light.” The samples are then further tested for their tensile properties. What is meant by “substantially non-destructive manner” is a proton transport mechanism similar to that described in H. Salaman et al. “Molecular and supramolecular proton-transfer processes in 2(2′-hydroxyphenyl)-3H-imidazo[4,5-b]pyridine and its derivatives” Journal of Luminescence 102-103 (2003) 261-266.

This invention will now be illustrated by the following specific examples:

### Comparative Example 1

In the Comparative Example 1, thirty layers of fabric made from 930 dtex poly(p-phenylene terphthalamide) continuous filament yarn with a linear density of 1.36 dtex per filament, available from E. I. DuPont de Nemours and Company under the trademark Kevlar® 129, are used as a reinforcement with the fabric construction of 12.2×12.2 ends/cm. The tensile strength of the yarn is 24.3 gram/dtex, and the density of the fiber is 1.44 gram/cm³. After exposure to a—xenon-arc lamp fading apparatus, per AATCC test method 16-2003, for 360 hours, the yarn retains about 63% of its original tensile strength. The fabric layers are further processed to form a composite structure with an areal density of 1.63 psf and a thickness of 67 mm by consolidating the fabric layers via laminating each layer of fabric with a layer of polyethelene film. A ceramic plate of boron carbide, as the striking face, available from Cercom Inc. is adhered to the composite structure with epoxy for testing. The assembly is then tested against rifle round M-80 ball (148 grains) of 7.62×51 mm per NIJ ballistic standard 0101.04 for Level III. Both the ballistic performance and UV resistance of the armor apparatus of the example are expected to be poor.

### Comparative Example 2

In the Comparative Example 2, twenty-eight layers of fabric made from 1110 dtex poly(p-phenylene-2,6-benzobisoxazole) continuous filament yarn with a linear density of 1.36 dtex per filament, available from Toyobo Co., Ltd., under the trademark Zylon®, are used as a reinforcement with the fabric construction of 8.7×8.7 ends/cm. The tensile strength of the yarn is 37.8 gram/dtex, and the density of the fiber is 1.54 gram/cm3. After being exposed to a xenon-arc lamp fading apparatus for 360 hours, it retains about 55% of its original tensile strength. The fabric layers are further processed to form a composite structure with an areal density of 1.41 psf and a thickness of 61 mm by consolidating the fabric layers via laminating each layer of fabric with a layer of polyethelene film. A ceramic plate of boron carbide, as the striking face, available from Cercom Inc. is adhered to the composite structure with epoxy for testing. The assembly is then tested against rifle round M-80 ball (148 grains) of 7.62×51 mm per NIJ ballistic standard 0101.04 for Level III. UV resistance of the armor apparatus of this example is poor.

### Example 1

In the Example 1 of this invention, twenty-six layers of fabric of 930 dtex poly{2,6-diimidazo[4,5-b4′,5′-e]pyridinylene-1,4(2,5-dihydroxy)phenylene} continuous filament yarn with a linear density of 1.36 dtex per filament are used as a reinforcement with the fabric construction of 12.2×12.2 ends/cm. The tensile strength of the yarn is 32.7 gram/dtex, and the density of the fiber is 1.65 gram/cm3. After being exposed to a xenon-arc lamp fading apparatus for 360 hours, the yarn retains about 91% of its original tensile strength. The fabric layers are further processed to form a composite structure with an areal density of 1.41 psf and a thickness of 58 mm by consolidating the fabric layers via laminating each layer of fabric with a layer of polyethelene film. A ceramic plate of boron carbide, as the striking face, available from Cercom Inc. is adhered to the composite structure with epoxy for testing. The assembly is then tested against rifle round M-80 ball (148 grains) of 7.62×51 mm per NIJ ballistic standard 0101.04 for Level III. The measured ballistic performance of the present invention improves on that of the above prior art examples. Additionally, both the weight and thickness, and therefore bulkiness of the armor apparatus of this invention are greatly reduced, while its UV resistance, and therefore stability are much better than that of the prior art, as described in Comparative Examples 1 and 2.

While the present invention has been described in connection with certain preferred embodiments, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

All patents and publications disclosed herein are incorporated by reference in their entirety.

What is claimed:

1. A penetration resistant composite, comprising:
a plate; and
a plurality of fibrous layers disposed adjacent at least one major surface of the plate, at least one of the fibrous layers including a polymer fiber having a density of 1.6 grams per cubic centimeter or greater and a tensile strength of at least about 30 grams per denier;
wherein the polymer fiber is ultraviolet stable so as to retain at least about 70% of its tensile strength after exposure to a xenon-arc lamp, in accordance with AATCC test method 16-2003, for about 360 hours.

2. The composite of claim 1, wherein the polymer fiber is ultraviolet stable in the absence of additives selected from a group comprising ultraviolet stabilizers and ultraviolet absorbers.

3. The composite of claim 1, wherein the polymer fiber retains at least about 85% of its tensile strength after exposure to a xenon-arc lamp, in accordance with AATCC test method 16-2003, for about 360 hours.

4. The composite of claim 4, wherein the polymer fiber includes a polyareneazole fiber.

5. The composite of claim 4, wherein the polyareneazole fiber is a poly{2,6-diimidazo[4,5-b:4′,5′-e]pyridinylene-1,4-(2,5-dihydroxy)phenylene} fiber.

6. The composite of claim 1, wherein the polymer fiber has a tensile modulus of greater than about 1,500 grams per denier.

7. The composite of claim 1, wherein the composite has an areal density of less than about 25 kilograms per square meter.

8. The composite of claim 1, wherein the fibrous layers have a total thickness of less than about 7.5 millimeters.

9. The composite of claim 1, wherein the areal density of fibrous layers is less than 7.5 kilograms per square meter.

10. The composite of claim 1, wherein the fibrous layers are disposed adjacent opposing major surfaces of the plate.

11. The composite of claim 1, further comprising a at least one ultraviolet stabilizing agent.

12. The composite of claim 10, wherein the ultraviolet stabilizing agent is selected from a group comprising benzophenone, benzotriazole, and mixtures thereof.

13. The composite of claim 1, wherein the plate comprises ceramic, steel, aluminum, glass, or a polymeric resin.

14. A penetration resistant composite, comprising:
a first layer; and
a plurality of fibrous layers disposed adjacent at least one major surface of the first layer, at least one of the fibrous layers having a thickness less than about 7.5 millimeters;
wherein the composite has an areal density of less than about 25 kilograms per square meter, and is non-penetratable in accordance with standard NIJ-0101.04 level III dated September 2000; and
wherein the fibrous layers include a polymer fiber that retains at least about 70% of its original tensile strength after exposure to a xenon-arc lamp, in accordance with AATCC test method 16-2003, for about 360 hours.

15. The composite of claim 14, wherein the fibrous layers include a polymer fiber that has a density of least about 1.6 grams per cubic centimeter and a tensile strength of at least about 30 grams per denier.

16. The composite of claim 14, wherein the fibrous layers include a polyareneazole fiber.

17. The composite of claim 16, wherein the polyareneazole fiber is a poly{2,6-diimidazo[4,5-b:4′,5′-e]pyridinylene-1,4-(2,5-dihydroxy)phenylene} fiber.

18. The composite of claim 14, wherein first layer is a rigid plate comprising ceramic, steel, aluminum, glass, or a polymeric resin.

19. A method of forming a penetration resistant article comprising:
providing a first layer; and
disposing a plurality of fiber layers on at least one major surface of the first layer, wherein the polymer fiber is ultraviolet stable so as to retain at least about 70% of its tensile strength after exposure to a xenon-arc lamp, in accordance with AATCC test method 16-2003, for about 360 hours.

20. The method of claim 19 wherein the first layer is a plate that comprises ceramic, steel, aluminum, glass, or a polymeric resin and the polymer fiber includes at least one polyareneazole fiber.
